(19) United States
(12) Patent Application Publication
(10) Pub. No.: US 2006/0096037 A1
(43) Pub. Date: May 11, 2006

(54) Method for preventing the shrinkage of woolen or wool blend fabrics

(76) Inventor: Massimo Guarducci, Prato (IT)

Correspondence Address: Serafini Associates, 7660 FAY AVE. STE H378, LA JOLLA, CA, 92037, US

(21) Appl. No.: 10/544,147

(22) PCT Filed: Feb. 5, 2004
(86) PCT No.: PCT/IT04/00041

§ 371 Date: Aug. 2, 2005

(30) Foreign Application Priority Data
Feb. 6, 2003 (IT) MI2003A000201

(51) Int. Cl. C11D 3/00

(52) U.S. Cl. 8/115.51

(57) ABSTRACT

Method for preventing the shrinkage of woolen or wool blend fabrics during water washing treatment, comprising the initial impregnation of the fabric of interest with a reducing product (compound A) and after suitable mechanical and drying treatment, the subsequent contact of the resulting fabric with a blend of products comprising at least one compound of each of the following groups: vinylic and acrylic resins, ethylene vinyl acetates, blocked or non-blocked isocyanates, blocked or non-blocked in water and solvents polyisocyanates (compound B); blocked or non-blocked in water and solvents polyisocyanates (compound C); silicon emulsions, macro-emulsions, cationic fabric conditioners (compound D).

The present invention relates to a method for preventing the shrinkage of woolen or wool blend fabrics during water washing operations. This method substantially comprises a treatment of the fabric of interest with suitable blends of chemical products, which, in turn, form an integral part of the invention.

Woolen or wool blend articles are normally dry-cleaned to eliminate greasy dirt, but a perfect cleaning is not obtained with respect to common dust, unfortunately to the detriment of people suffering from allergies; furthermore, exhalations of the products used in dry cleaning cause water and atmosphere pollution (law of Dec. 28, 1993 nr. 549 modified by the law of Jun. 11, 1996 nr. 315). In return, water washing certainly offers greater hygiene but does not guarantee that the woolen or wool blend article does not modify its structure.

The Applicant has now found, and this is the object of the present invention, that it is possible to give dimensional stability to woolen or wool blend fabrics by means of treatment with suitable combinations of chemical products, which also form an object of the present invention. Articles manufactured with the fabric thus treated can be subjected to water washing at a temperature of about 30/40° C. in specific laundry machines or household washing machines, preventing macroscopic felting.

Chemical processes are known for conferring unshrinkability to woolen articles, but they are only a few of these which normally refer to knitted or combed fabrics. Chemical treatment used for anti-felting processes are substantially the following:
degradation processes (oxidation, in particular), which are effected using chlorine or organic derivatives of chlorine in an aqueous medium: this treatment causes more or less damage to the woolen fibers, such as weight loss, a reduction in mechanical resistance, a decrease in the elasticity, all unfavorable changes on the final result of the fabric (normally called “feel”);
additional processes, by applying polymers such as polyamines, polyacrylates, reactive polyolefins;
processes deriving from the combination of those mentioned above.

The method set up by the applicant and which, as already mentioned, constitutes an object of the present invention, makes use of a suitable combination of known techniques and, at the same time, applies these techniques by using a particular combination of chemical products which confer unshrinkability to woolen fabrics and do not produce any of the undesired side effects which, according to the known art, derive from the use of the above-mentioned chemical products on the woolen fabrics.

An object of the present invention therefore relates to a method for preventing the shrinkage of woolen or wool blend fabrics during water washing treatment, consisting of subjecting the fabric of interest to a combined action of a reducing product and a further three products to be added in a subsequent phase, and sending the fabric thus treated to suitable squeezing and finishing operations.

This treatment, in addition to preventing the macroscopic felting of the article during washing in household washing machines, also prevents the final deterioration of the fabric, which is inevitable in the treatment of the known art, and, finally, also allows the heaviest woolen articles, such as jackets, trousers and overcoats, to be treated.

In particular, the present invention relates to a method for preventing the shrinkage of woolen and wool blend fabrics during water washing operations which includes the initial impregnation of the fabric of interest with a reducing compound and, after suitable mechanical and drying treatment, subjecting the resulting fabric to the action of a blend of products comprising at least one compound for each of the following groups:
vinylic and acrylic resins, ethylene vinyl acetates, blocked or non-blocked isocyanates, blocked or non-blocked in water and solvents polyisocyanates;
blocked or non-blocked in water and solvents polyisocyanates;
silicon emulsions, silicon micro-emulsions, macro-emulsions, cationic fabric conditioners.

The fabric thus obtained is finally mechanically treated and dried.

The reducing compound (compound A) is selected from sulfites, di-sulfites and formiates; a single compound can be used, or a mix of two or more substances at various concentrations and percentages.

With respect to the compounds adopted for carrying out the second phase of the treatment, these are used, according to different percentages, in a mix whose combination is, in turn, an object of the present invention. This combination, as mentioned, uses at least one compound for each of the above-mentioned groups which, once again, are:
Compound B: vinylic and acrylic resins, ethylene vinyl acetates, blocked or non-blocked isocyanates, blocked or non-blocked in water and solvents polyisocyanates;
Compound C: blocked or non-blocked in water and solvents polyisocyanates;
Compound D: silicon emulsions, silicon micro-emulsions, macro-emulsions, cationic fabric conditioners.

The above products, as such or in blends of suitable percentages, are put in contact with the fabric to be treated in amounts of up to 50% by weight with respect to the total weight of the fabric. The treatment is effected on the fabric, before manufacturing the items of clothing, and is substantially inserted in the finishing steps of the fabric.

The method according to the present invention comprises the treatment of fabric in several steps:
the fabric is impregnated with compound A at a temperature ranging from 0° C. to
the fabric thus treated is subjected to squeezing or centrifugation, then dried;
the fabric thus obtained is impregnated with compound BCD at a temperature ranging from 0° C. to 100° C. When the BCD compound is a blend, the products are present in various percentage ratios, whose value is selected by experts in the field on the basis of the results to be achieved;
finally, the fabric is squeezed and/or centrifuged and dried.

The following example will add further details to and contribute to providing a better illustration of the method according to the present invention, without, however, limiting its scope.

### EXAMPLE

1^{st} Step

The treatment or pad bath is heated to a temperature ranging from about 20° C. to 100° C. (FIG. 1) in the presence of one or more products selected from the reducing compounds, care being taken not to create stress in the warp and ensuring that the bath penetrates inside the fabric and not only on the surface, consequently exerting a pressure of 40-50 bar by squeezing or basket centrifugation.

The fabric is dried at a temperature of 110-120° C. over the drying stenter (drying machine).

The fabric is fed to the stenter machine—care being taken not to exceed a height of 5/10 cm in the stenter machine above the height of the finished fabric, as this can create too much stress—until the fabric reaches its regular warp tension, subsequently recovering its initial conditions in dimensional terms (before step 1 of the treatment).

The fabric leaves the stenter machine dried.

2^{st} Step

The fabric is inserted into an intermitted barrel decatizing machine with “molleton” or “glazing finish” supplying vapour for 4 minutes, continuously, with no pump, care being taken that there is no locking or stress in the warp or in a KD machine.

It is recommended to mark two signals at about 1 meter from the headboard in the warp direction. The reciprocal distance between the signals should be 100 cm, to control the operation and prevent locking or stress. This control should be effected for all productions, in order to discover working methods which can generate undesired stress and consequently make the desired corrections.

The fabric thus treated can then be submitted to the necessary finishing operations.

It should therefore be dried again, with the usual precautions for weave stress and warp overfed to the maximum, the distances of the two signals being constantly restored to 100 cm, as described above.

3^{rd} Step

The pad bath is prepared again for the second combination of products, consisting of one or more products selected from B, C and D; the drying phase in the stenter machine is then effected, care being taken to observe all methods and precautions already mentioned in Step 1 and 2. The fabric is vaporized and rolled up.

For the treatment in question, the tank (FIG. 1) should be equipped with a minimum of three and a maximum of five cylinders, situated, respectively: nr. 1 immersed in the bath and nr. 2 out of the bath; nr. 3 immersed in the bath and nr. 2 out of the bath. The bath temperature ranges from 20 to 100° C.

The contact of the fabric with the cylinders has a sponge effect, the liquid penetrates inside the depth of the fabric and is definitely dried with various types of equipment.

1. A method for preventing the shrinkage of woolen or wool blend fabrics during water washing treatment, comprising the initial impregnation of the fabric of interest with a reducing product (compound A) and, after suitable mechanical and drying treatment, the subsequent contact of the resulting fabric with a blend of products comprising at least one compound of each of the following groups:
vinylic and acrylic resins, ethylene vinyl acetates, blocked or non-blocked isocyanates, blocked or non-blocked in water and solvents polyisocyanates (compound B);
blocked or non-blocked in water and solvents polyisocyanates (compound C);
silicon emulsions, macro-emulsions, cationic fabric conditioners (compound D).

2. The method for preventing the shrinkage of woolen or wool blend fabrics according to the previous claim, wherein the reducing product (A) consists of one or more compounds selected from sulfites, di-sulfites and formiates.

3. The method for preventing the shrinkage of woolen or wool blend fabrics according to claim 1, wherein the products selected from A, B, C and D, as single compounds or as blends of more compounds, are put in contact with the fabric to be treated in a total amount of up to 50% by weight with respect to the total weight of the fabric.

4. The method for preventing the shrinkage of woolen or wool blend fabrics according to claim 1, wherein the two treatments with the above-mentioned products are carried out at temperatures ranging from 20 to 100° C.

5. Blend of compounds to be used in a treatment for preventing the shrinkage of woolen or wool blend fabrics during water washing operations, comprising at least one compound of each of the following groups:
vinylic and acrylic resins, ethylene vinyl acetates, blocked or non-blocked isocyanates, blocked or non-blocked in water and solvents polyisocyanates;
blocked or non-blocked in water and solvents polyisocyanates;
silicon emulsions, macro-emulsions, cationic fabric conditioners.
